(19) United States
(12) Patent Application Publication
(10) Pub. No.: US 2010/0092645 A1
(43) Pub. Date: Apr. 15, 2010

(54) SALAD DRESSING COMPOSITION

(76) Inventors: Willem Pieter Antheunisse, Vlaardingen (NL); Hendrikus Theodorus W M Van der Hijden, Vlaardingen (NL)

Correspondence Address: UNILEVER PATENT GROUP, 800 SYLVAN AVENUE, AG West S. Wing, ENGLEWOOD CLIFFS, NJ, 07632-3100, US

(21) Appl. No.: 12/519,773

(22) PCT Filed: Nov. 28, 2007
(86) PCT No.: PCT/EP2007/062954

§ 371 Date: Jun. 18, 2009

(30) Foreign Application Priority Data
Dec. 21, 2006 (EP) 06126854.6

(51) Int. Cl. A23L 1/24

(52) U.S. Cl. 426/575; 426/589; 426/577; 426/573

(57) ABSTRACT

Salad dressing compositions comprising from 1 to 50% of an oil phase and from 50% to 99% of a an aqueous phase, said aqueous phase comprising from 0.1 to 0.6% by weight of acetic acid and a further acid having a pKa of less than 2.5, said composition having a pH between 2.5 and 4.5, provide improved longer term properties, such as colour, leaf integrity, volume and overall appearance of the salads.

### FIELD OF THE INVENTION

The present invention relates to salad dressing compositions. More in particular, it relates to salad dressing compositions which are intended for the catering and institutional market, such as in-flight catering or restaurants, old people's homes, hospitals, etc.

### BACKGROUND TO THE INVENTION

Conventional dressings for use on salads, especially those in use in Mediterranean countries, are emulsions of an oil phase (e.g. 50-60%) in a water phase. The water phase contains vinegar and optionally further contains salt, herbs, and spices. As the size of the oil droplets in these dressings is around 0.2-5 mm it is easily visible by the eye that oil is present. Such dressings are conventionally prepared fresh by the housewife by shaking or stirring oil (40-70%), vinegar (60-30%) and optionally salt, herbs together, to give a translucent, emulsified but not very stable salad dressing. Such dressing will generally be used directly after mixing and before phase separation occurs.

U.S. Pat. No. 3,955,010 (Kraft) discloses emulsified oil dressings which are resistant to bacteriological spoilage at room temperature, comprising from about 1 to 50% of an edible vegetable oil and an edible acid to provide a pH of below about 4.1.

U.S. Pat. No. 4,927,657 (The Clorox Company) discloses salad dressing comprising from a preservation system comprises at least two edible acids selected from phosphoric, acetic, fumaric, lactic, citric, adipic, malic, tartaric and hydrochloric acids. The best salad quality is obtained when a salad dressing is added to the salad just before consumption. However, in the institutional foods business such as in-flight catering or old people's homes, salads are often prepared several hours before they are consumed and consequently, special longer term requirements exist with regard to colour, leaf integrity, volume and overall appearance of the salads after they have been prepared.

It is therefore an object of the present invention to provide a salad dressing composition capable of providing improved longer term sensory properties, such as colour, leaf integrity, volume and overall appearance of the salads. It is a further object of the invention to provide a process for the preparation of the salad dressing composition.

It was surprisingly found that these and other objects of the invention could be achieved by the salad dressing composition according to the invention, comprising from 1 to 50% of an oil phase and from 50% to 99% of a an aqueous phase, said aqueous phase comprising from 0.1 to 0.6% by weight of acetic acid and a further acid having a pKa of less than 2.5, said composition having a pH between 2.5 and 4.5.

### SUMMARY OF THE INVENTION

According to a first aspect, the invention provides a salad dressing composition comprising 1 to 50% of an oil phase and from 50% to 99% of a an aqueous phase, said aqueous phase comprising from 0.1 to 0.6% by weight of acetic acid and a further acid having a pKa of less than 2.5, said composition having a pH between 2.5 and 4.5.

According to a second aspect, there is provided a process for preparing such a salad dressing composition.

According to a third aspect, there is provided an industrial use of the salad dressing composition of the invention, whereby salad is treated with a salad dressing composition according to the invention, and subsequently left for at least two hours before the salad is consumed.

### DETAILED DESCRIPTION OF THE INVENTION

According to the present invention it has become possible to prepare a salad dressing composition having excellent longer term properties, such as colour, leaf integrity, volume and overall appearance of the salads.

By salad we mean any leafy type of single or mixed vegetables, such as lettuce, but other types of vegetables may be included such as carrots, tomato, and cucumber. Moreover, other ingredients like pieces of cheese, meat, fish, nuts, seeds and breadcrumbs may be included.

The first component of the salad dressing composition of the invention is the oil phase. Examples of suitable oils for use in the oil phase of salad dressing composition of the invention are sunflower seed oil, rapeseed oil, soybean oil, olive oil and mixtures of them.

In this specification, unless otherwise indicated, the term ‘oil’, when used in a general sense, refers to edible fatty substances including natural or synthesized fats and oils consisting essentially of triglycerides such as, for example, soybean oil, sunflower oil, palm oil, coconut oil, and to non-toxic fatty materials having properties similar to triglycerides, which materials may be indigestible, such as for example polyol fatty acid polyesters. The terms fat and oil are used interchangeably, with the proviso that oil denotes a fat which is liquid at ambient temperatures.

Furthermore, in order to be appreciated as an acceptable salad dressing, the composition must contain acetic acid in an amount from 0.1 to 0.6% by weight of the aqueous phase.

If not indicated otherwise, all weight % used throughout this specification and claims are calculated on the total weight of the composition.

For the preparation of the acid water phase, acetic acid and a further acid having a pKa of less than 2.5, preferably an edible acid, should be used. The further acid is preferably selected from phosphoric acid, sulfuric acid, hydrochloric acid, glutamic acid, maleic acid, oxalic acid, tartaric acid, aspartic acid and betaine.

Preferably, the salad dressing compositions according to the invention comprise from 0.001 to 0.1% by weight of phosphoric acid. The overall pH of the salad dressing compositions according to the invention is between 2.5 and 4.5.

The invention comprises also a process for the preparation of a salad dressing composition according to the invention, comprising the steps of (a) preparing an aqueous solution of an emulsifier, (b) adding the oil phase and (c) adding the acetic acid and the further acid to the obtained emulsion.

The emulsion is prepared by stirring the oil phase into the ready water phase at a temperature of 10-40° C., preferably at ambient temperature, into under low shear conditions, preferably with a high convection effect. Suitably a low shear, low speed blender of a type which is usually applied for dressing manufacture is used for that purpose. Stirring is continued until the oil phase is totally dispersed into the water phase. The oil droplets advantageously have an average size of 5-30 μm, preferably 15 μm. Stirring for a too long time or with too much shear yields an undesirably pale coloured dressing on account of the particles becoming too small.

Optionally, other flavouring ingredients such as salt, pepper, mustard, herbs and spices are incorporated into the emulsion. The total amount of other flavouring ingredients preferably is 0.01-4 wt. %.

When the oil phase is not immediately mixed with the water phase, it is convenient to add at least a part of the optional ingredients to the oil phase. Preferably, the optional ingredients are admixed with the acid water phase which is then emulsified with the oil phase yielding the pourable emulsion of the invention.

Typically, some emulsifier, preferably 0.2-1.0 wt. %, more preferably about 0.5 wt. %, is added to enhance the emulsion stability. Suitable emulsifiers are e.g. monoglycerides, diglycerides, phospholipids and polyglycerol esters.

If desired the water phase may be stabilised by incorporating any water phase stabiliser. Suitable stabilisers are e.g. gelatin, gums, alginate, pectin, modified starches and proteins.

The salad dressings of the invention have a good pourability and fluidity. Physical stability is ensured for at least six and preferably nine months. A typical application of the salad dressing composition of the invention is the application in an institutional food process, whereby salad is treated with a salad dressing composition according to the invention, and subsequently left for at least two hours, preferably four, six, 24 or even 48 hours before the salad is consumed.

The invention will now be illustrated by means of the following non-limiting examples.

### Example 1

This experiment was designed to investigate the influence of the acetic acid concentration on salad quality. Leaves of iceberg lettuce were submerged in a 1-litre beaker flask filled with 650-ml aqueous acetic acid solutions of table 1. The pH of all solutions was set to pH 3.0 with 3M HCl. After a 24-hour incubation the lettuce iceberg) was washed with tap water and visually assessed on colour, sogginess, volume and overall appearance.

TABLE 1
Effect of Acetic acid concentrations on lettuce
quality (higher positive score = better quality)

| % acetic | | | |
|---|---|---|---|
| acid | initial pH | Final pH | Panel score |
| 0.23 | 3.05 | 3.0 | −−− |
| 0.15 | 3.15 | 3.0 | −− |
| 0.1 | 3.32 | 3.0 | − |
| 0.066 | 3.53 | 3.0 | +/− |
| 0.05 | 3.67 | 3.0 | + |
| 0.033 | 3.93 | 3.0 | ++ |
| 0.017 | 4.38 | 3.0 | ++ |
| 0.008 | 5.48 | 3.0 | +++ |
| 0.004 | 6.13 | 3.0 | +++ |
| 0 | 6.98 | 3.0 | +++ |

The lettuce incubated in the lowest concentrations (up to 0.008%) of acetic acid perfectly retained its colour, appearance and was as crisp as fresh leaves. Acetic acid concentrations between 0.0017 and 0.05% had a small but significant negative effect on the quality parameters of the lettuce, but at acetic acid concentrations above 0.066% (w/w) the leaves completely lost both their fresh green colour and structure.

### Example 2

This example illustrates the impact of the nature and concentration of the acids on lettuce quality. Lettuce ('iceberg') leaves were submerged a 1-litre beaker flask filled with a 650-ml aqueous solution containing four different acids (phosphoric, citric, lactic and acetic acid) at three different concentrations (25, 37.5 and 75 mM). The pH of all solutions was set at 3.0 with concentrated NaOH or HCl. The quality of the lettuce leaves after 18 hours of incubation was visually assessed on colour, leaf integrety, volume and overall appearance after incubation by an in-house sensory panel (the lowest score indicates the best quality).

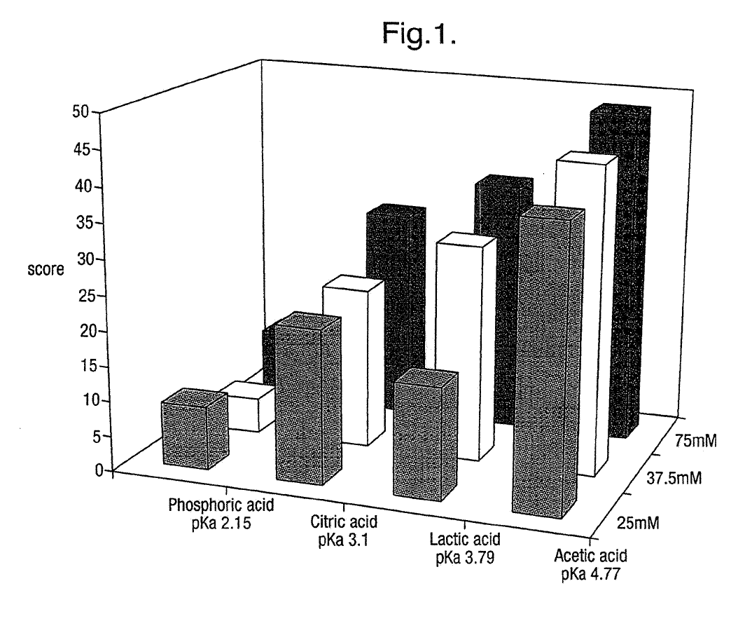

Ranking based on visual assessment by the in-house sensory panel of the stability of the salad leaves (FIG. 1) shows that the nature of the acid plays a more important role than its concentration. Acids with higher pKa values seem to be more detrimental to lettuce quality than the stronger acids. Acetic acid with the highest pKa (4.77) of this series, showed a strong negative impact on the lettuce leaf quality even at its lowest concentration of 25 mM, whereas phosphoric acid with the lowest pKa value (2.15) of this series only had a weak negative impact on the lettuce quality. In general it was observed that the acids with a pKa above 3 had a stronger negative influence on the leaf quality.

### Example 3

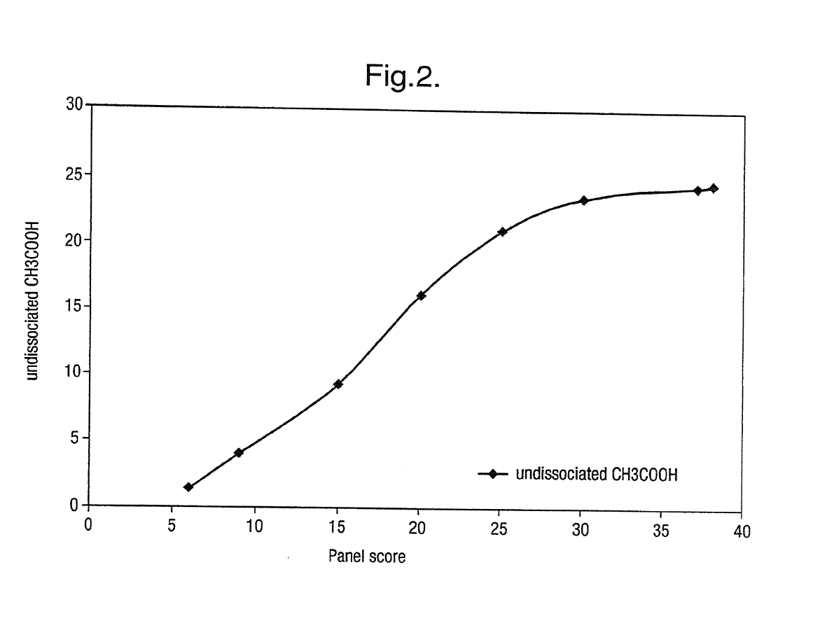

The impact of undissociated and dissociated forms of acetic acid on lettuce leave quality was also tested in the same set up as example 1. Lettuce leaves ('Iceberg') were submerged in 650 ml tap water with 0.15% acetic acid. The different concentrations of undissociated acetic acid were established by adjusting the pH in the range from pH 2.5 to 6.0 with concentrated HCl and NaOH. After incubation at room temperature for 24 hours the quality of the lettuce leaves was assessed by the sensory panel. The results of the sensory assessment, depicted in FIG. 2 clearly show that the lettuce leaves incubated with higher amounts of undissociated acetic acid have lower sensory quality.

### Example 4

Effect of Acetic Acid in Dressing Formulation on Salad Quality.

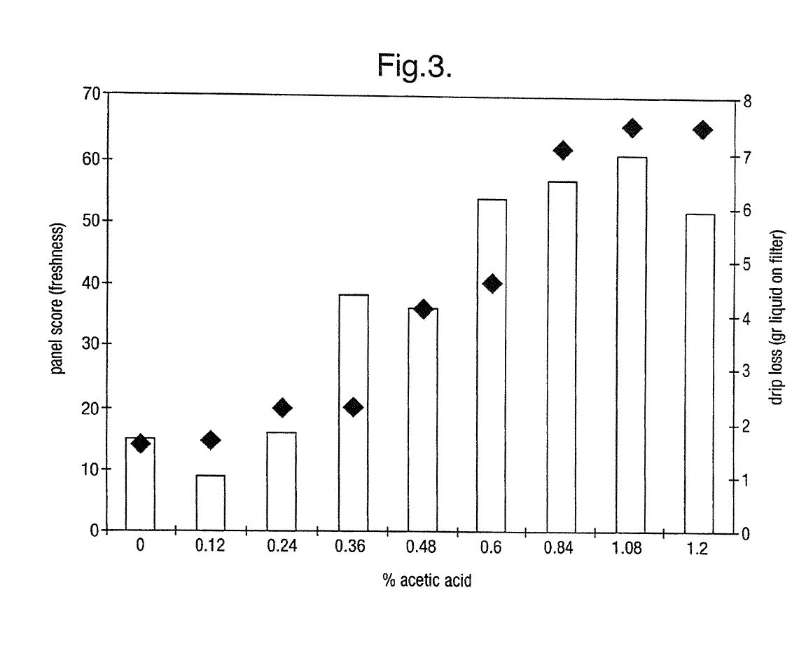

To test the effect of acid in the dressing formulation a series of experimental dressings were prepared. All dressings contained 4% sugar, 19% sunflower oil, 1% salt and 0.7% carragenan and had an acetic acid content ranging from 0 to 1.2% (w/w). The pH of all dressings in this series was set to 3.0. Mixed lettuce salads were prepared with the series of dressings and allowed to stand for 24 hours at 4° C. before assessment by a sensory panel. FIG. 3 shows both, the quality deterioration, as assessed by the sensory panel and the drip loss increased with increasing acetic acid content. (The lower the bar, the better the quality).

### Example 5

To check the effect of acetic acid, mixed lettuce salads prepared with a few formulations of the above experiment were compared 24 hours after preparation in one experiment. The overall results are listed in table 2. This experiment confirmed the finding of the former experiment. The appearance (freshness) of salad was reasonably retained up to 0.6% acetic acid, but a lot of drip loss at that acetic acid concentration was observed.

TABLE 2
The effect on drip loss and freshness of lettuce for
three concentrations of acetic acid.

| | 0.12% HAc | 0.6% HAc | 1.2% HAc |
|---|---|---|---|
| freshness | ++ | +/− | − |
| drip loss | ++ | −− | −− |

### Example 6

In this example, the influence of the acetic acid content of a dressing on salad quality was determined over longer storage times. The dressings were made with three different acetic acid concentrations.

Dressing Preparation.

Three dressings with different acetic acid contents were prepared in a Hobart mixer. The bowl was first filled with sugar, carragenan, NaCl and KCl. The ingredients were mixed well by hand with the stainless steel wire whip attachment of the Hobart mixer. Then hot water (60° C.) was added and the Hobart mixer was used on level 2 during for 5 minutes. Then the oil and subsequently the acetic acid were added slowly during mixing. After 10 minutes the bowl was covered with a tea towel to prevent splatter and the ingredients were mixed during 1 minute at level 3. The pH of the dressing with the lowest acetic acid content (0.24%) was set to pH 3.0 with concentrated HCl.

TABLE 3
Dressing compositions

| Ingredient | %* | % | % |
|---|---|---|---|
| Sugar | 4 | 4 | 4 |
| K carrageen (X9090) | 0.7 | 0.7 | 0.7 |
| KCl | 0.1 | 0.1 | 0.1 |
| NaCl | 0.9 | 0.9 | 0.9 |
| Acetic acid | 0.24 | 0.7 | 0.9 |
| Tap water (60°) | 75.06 | 74.6 | 74.4 |
| Sunflower oil | 19 | 19 | 19 |

*The amounts of the different ingredients are expressed in weight percentage (w/w).

Application of Dressing Formulations on Mixed Vegetable Salad

Dressings (42 g) from table 3 were applied to 125 g of mixed vegetable salads (mix of Iceberg salad (73%), carrots, white cabbage and red salad, stored at 4° C. in plastic bags of 200 g under a nitrogen atmosphere before the test). The dressing and lettuce were mixed carefully with a spoon to obtain maximal wetting of the leaves. The above salads were covered with plastic folio and allowed to stand in the dark at 4° C. At different time intervals (between 30 minutes and 45 hours) the salads were assessed by an in-house sensory panel at different time intervals within the first 45 hours after preparation. The drip loss of duplicate salad preparations was measured at the same time intervals.

Sensory Evaluation of Salad.

The quality of the mixed salads was visually assessed on colour, sogginess, volume and overall appearance after incubation. The sensory panel ranked the salad on the above quality attributes (lowest score relates to best quality).

TABLE 4
Panel scores or sensory quality of salads treated with dressing
formulations of table 3. Ranking: 1, 7, 4, 9, 2, 8, 3, 6, 5.

| Time and acetic acid % (w/w) | Panel score |
|---|---|
| 1) 45 hours 0.24% acetic acid | 6 |
| 2) 45 hours 0.7% acetic acid | 31 |
| 3) 45 hours 0.9% acetic acid | 35 |
| 4) 29 hours 0.24% acetic acid | 15 |
| 5) 29 hours 0.7% acetic acid | 37 |
| 6) 29 hours 0.9% acetic acid | 36 |
| 7) 21 hours 0.24% acetic acid | 14 |
| 8) 21 hours 0.7% acetic acid | 33 |
| 9) 21 hours 0.9% acetic acid | 20 |

Drip Loss.

After incubation the salad with the dressing formulation was placed on a filter paper. After 10 minutes the salad was removed and the amount of liquid absorbed on the filter paper was determined gravimetrically.

TABLE 5
Drip loss of salads treated with dressing formulations
of table 3.

| | time | acetic acid | Drip loss |
|---|---|---|---|
| nr | (hours) | [% w/w] | [gr.] |
| 1 | 45 | 0.24 | 1.48 |
| 2 | 45 | 0.7 | 8.75 |
| 3 | 45 | 0.9 | 10.3 |
| 4 | 29 | 0.24 | 1.47 |
| 5 | 29 | 0.7 | 4.5 |
| 6 | 29 | 0.9 | 5.52 |
| 7 | 21 | 0.24 | 1.2 |
| 8 | 21 | 0.7 | 2.59 |
| 9 | 21 | 0.9 | 4.3 |
| 10 | 5 | 0.24 | 1.6 |
| 11 | 5 | 0.7 | 2.19 |
| 12 | 5 | 0.9 | 2.00 |
| 13 | 2.5 | 0.24 | 1.07 |
| 14 | 2.5 | 0.7 | 2 |
| 15 | 2.5 | 0.9 | 1.56 |
| 16 | 1 | 0.24 | 1.35 |
| 17 | 1 | 0.7 | 1.1 |
| 18 | 1 | 0.9 | 0.96 |
| 19 | 0.5 | 0.24 | 1.03 |
| 20 | 0.5 | 0.7 | 1.18 |
| 21 | 0.5 | 0.9 | 1.58 |

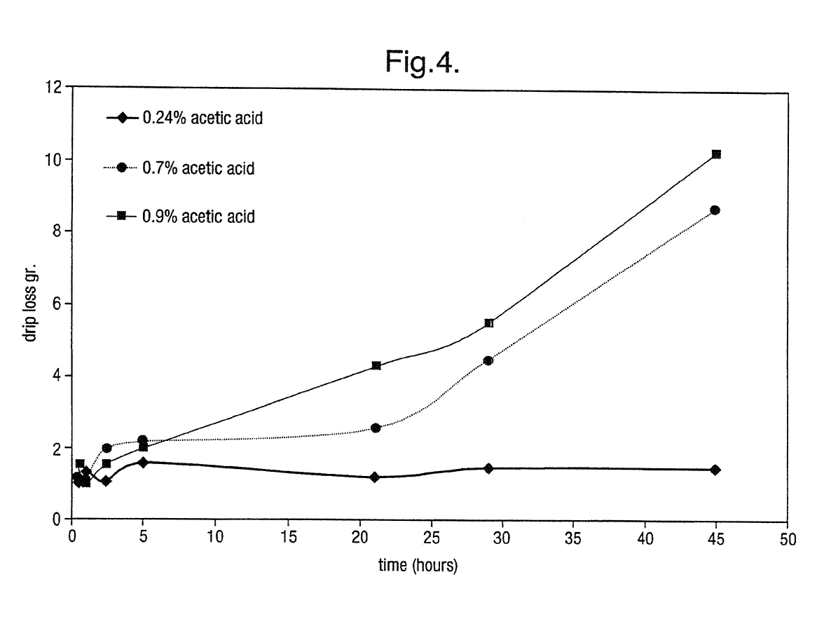

In contrast to the salads prepared with dressings with a higher acetic acid content, the salad prepared with the dressing according to the invention (0.24% HAc) still had a fresh appearance after 45 hours. Moreover the two salads prepared with the dressing with the higher acetic acid concentrations showed a higher drip loss than the dressing of the invention. The difference in drip loss became apparent after only 1 and progressively increases during the next 44 hours (FIG. 4).

### Example 7

Microscopic Observations of Submerged Lettuce Leaves.

The influence of acetic acid on the microstructure of lettuce leaves was inspected by Confocal Scanning Light Microscopy (CSLM). After 24 hours submerged incubation at 4° C. in aqueous solutions of 0.12 and 1.2% acetic acid and in water (reference) pieces of lettuce were rinsed in tap water and stained with Acridin orange. The cells of the spongy layer of the lettuce treated with 1.2% HAc appeared to be slightly distorted but otherwise intact. The cells of the lower epidermis were shrunken, leaving microscopic clefts between the cells. The cells of the spongy layer of the lettuce leaves incubated in 0.12% had a significantly higher integrity than those incubated in 1.2 HAc, indicating that high acid concentration has a negative impact on the tissue integrity. It should be noted that the macroscopic observations of the lettuce leaves were quite different and showed perhaps more severe changes than the microscopic observations would suggest. Especially the colour differences were striking. In contrast to the lettuce treated with 0.12% HAc, the lettuce treated with 1.2% HAc totally lost its green colour.

Microscopic Observations of Lettuce Salad Prepared with Dressing

The influence of a dressing made 0.36% HAc on the microstructure of lettuce leaves was inspected by CSLM. Lettuce prepared with the dressing according to the invention was compared with the control reference (plain water). After 24 hours incubation at 4° C. pieces of lettuce were rinsed in tap water and stained with Acridin orange. The cells of the lettuce and especially the spongy layer of the lettuce prepared with dressing were shrunken as compared to the leaves treated with tap water. Moreover the chloroplasts of the lettuce treated with dressing seemed to have aggregated.

1. Salad dressing composition comprising from 1 to 50% of an oil phase and from 50% to 99% of an aqueous phase, said aqueous phase comprising from 0.1 to 0.6% by weight of acetic acid and a further acid having a pKa of less than 2.5, said composition having a pH between 2.5 and 4.5.

2. Salad dressing composition according to claim 1, wherein the further acid is a food-grade acid.

3. Salad dressing composition according to claim 1, wherein the further acid is selected from phosphoric acid, sulfuric acid, hydrochloric acid and glutamic acid.

4. Salad dressing composition according to claim 1, wherein the further acid is selected from maleic acid, oxalic acid, tartaric acid, aspartic acid and betaine.

5. Salad dressing composition according to claim 1, comprising from 0.001 to 0.1% by weight of phosphoric acid.

6. Salad dressing composition according to claim 1, wherein the oil phase comprises from 10 to 35% by weight of total composition.

7. Salad dressing composition according to claim 1, comprising a thickener.

8. Salad dressing composition according to claim 7, wherein the thickener is selected from pectins, xanthan gum, carragenan.

9. Salad dressing composition according to claim 1, characterised in that it further comprises 0.01-4 wt. % of one or more ingredients selected from the group comprising mustard, pepper, salt, herbs and spices.

10. Process for the preparation of a salad dressing composition according to claim 1.

11. Process for the preparation of a salad dressing composition according to claim 1, comprising the steps of preparing an aqueous solution of an emulsifier, adding the oil phase and adding the acetic acid and the further acid to the obtained emulsion.

12. Use of a salad dressing composition according to claim 1 in an institutional food process, whereby salad is treated with a salad dressing composition according to the invention, and subsequently left for at least two hours before the salad is consumed.
